(19) United States
(12) Patent Application Publication
(10) Pub. No.: US 2005/0064127 A1
(43) Pub. Date: Mar. 24, 2005

(54) Method of manufacturing a coupon card

(76) Inventors: James F. Turner, Farmington Hills, MI (US); Scott D. Best, Troy, MI (US); Dennis Michael King, Livonia, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/945,218

(22) Filed: Sep. 20, 2004

Related U.S. Application Data
(60) Provisional application No. 60/504,254, filed on Sep. 19, 2003.

(51) Int. Cl. B32B 9/00

(52) U.S. Cl. 428/40.1

(57) ABSTRACT

A manufacturing machine assembly and associated method for producing a coupon card. The machine assembly includes a support frame with a printing station for printing indicia on a top surface of a continuous sheet of stock in two parallel rows that define a first strip and a second strip of the stock. A forming station removes a release liner from the first strip to expose an adhesive layer. The forming station also moves the adhesive layer of the first strip into a bonded relationship with the release liner of the second strip to mate the first and second strips and form a continuous series of two-sided coupon cards. Exit rollers completely cut through the series of two-sided coupon cards for forming and separating individual coupon cards from the continuous sheet of stock. A first take-up roller collects a first continuous web of scrap stock. A scoring roller only cuts through a portion of the second strip of stock and a stripping roller removes the cut portion of the second strip of stock, which is now a second continuous web of scrap stock. A second take-up roller collects the second continuous web of scrap stock.

### CROSS-REFERENCE TO RELATED APPLICATIONS

The subject patent application claims priority to and all the benefits of U.S. Provisional Patent Application Ser. No. 60/504, 254, which was filed on Sep. 19, 2003.

### BACKGROUND OF THE INVENTION

1. Field of the Invention

The subject invention relates to a method of manufacturing a two-sided coupon card.

2. Description of Related Art

Coupon cards having a number of mini-coupons which may be removed and redeemed are well known. The mini-coupons are a popular means of attracting customers and encouraging additional sales. The prior art coupon cards and mini-coupons have various constructions and are used for a multitude of applications. Examples of some prior art coupon cards and mini-coupons are disclosed in U.S. Pat. Nos. 4,767,654; 5,299,834; and 5,308,120. These prior art coupon cards, however, have a number of deficiencies. Primarily, the mini-coupons are attached to a thin layer of laminated paper such that the coupon cards lack structural integrity once a mini-coupon is removed. Upon removal of a mini-coupon, the laminated paper backing is structurally insufficient for a card that will be repeatedly used. In particular, the coupon card will be bent repeatedly with each removal of the mini-coupons which weakens the bond between the paper and the remaining mini-coupons, as well as having the coupon card bend and fold undesirably.

Another prior art coupon card, having a unique and superior construction, is illustrated in U.S. Pat. No. 5,417,458. The '458 patent is assigned to the assignee of the subject invention and includes a novel structure of two layers of card stock sandwiching a liner with adhesive disposed between each layer of card stock and the liner. The two layers of card stock allow the mini-coupons to be removed while maintaining sufficient integrity and rigidity within the card itself. The mini-coupons are mounted to one side of the coupon card while informational messages, advertisements and the like are printed on an opposite side of the coupon card.

The preferred design for the prior art coupon cards is to have the mini-coupons disposed on one side of the coupon card such that some integrity of the card is retained as the mini-coupons are removed. In order to accommodate numerous mini-coupons on one coupon card, the card itself must be relatively large. Some examples of large coupon cards which may hold a number of mini-coupons are shown in U.S. Pat. Nos. 5,308,120 and 5,501,491. These prior art coupon cards are bulky, cumbersome and cannot be easily transported within a purse, wallet, carrying pouch or the like. These larger coupon cards also suffer from the deficiencies of having a weakened paper backing material.

To reduce the bulkiness of the coupon cards, a foldable coupon card was developed and is disclosed in U.S. Pat. No. 6,241,287. The '287 patent is assigned to the assignee of the subject invention and includes a first card and a second card, with a living hinge disposed therebetween. The living hinge defines a dual coupon card assembly wherein the first card may be folded upon the second card. The coupon card folds down to the size of a credit card to improve transportability of the coupon card in a purse, wallet, carrying pouch or the like.

However, the bulkiness of prior art coupon cards hinders the coupon cards from including additional card sections. In addition, when a new coupon card is issued, the coupons extend flush with outer edges of the coupon card. As a result, the mini-coupons may be difficult to access. For example, to remove the mini-coupons from the coupon card, either the coupon card itself must be bent, thus reducing the integrity of the coupon card, or the mini-coupons must be separated at the outer edge of the coupon card, which can be tedious and frustrating. The prior art coupon cards also are limited as to the number of mini-coupons that can be included on one coupon card. Such deficiencies may deter consumers from using the prior art coupon cards.

Another important commercial aspect relative to these prior art coupon cards is the means in which they are manufactured. In order to produce a coupon card that is economically feasible, it is advantageous to quickly and efficiently manufacture these coupon cards using a high speed manufacturing machine that eliminates any manual intervention during the manufacture of these cards. Machines for manufacturing coupon cards are known in the art, such as U.S. Pat. Nos. 5,776,287 and 6,315,023. The machines disclosed in the '287 and '023 patents, however, do not provide a means to reduce the bulkiness of the coupon cards while simultaneously providing easier access to the mini-coupons.

Accordingly, it would be preferable to develop a method of manufacture that is fast and efficient while eliminating any manual handling of the card and avoiding the deficiencies outlined above.

### SUMMARY OF THE INVENTION AND ADVANTAGES

The invention includes a card manufacturing machine assembly for producing a coupon card fabricated from a continuous sheet of stock having a top surface and a bottom surface with an adhesive layer and release liner disposed on said bottom surface. The manufacturing machine assembly comprises a support frame for supporting the continuous sheet of stock as the sheet of stock moves through the machine assembly. A printing station is provided for printing indicia on the top surface of the continuous sheet of stock in two parallel rows that define a first strip and a second strip of the stock. A forming station removes the release liner from the first strip to expose the adhesive layer. The forming station also moves the adhesive layer of the first strip into a bonded relationship with the release liner of the second strip to mate the first and second strips and form a continuous series of two-sided coupon cards wherein the first strip defines the top surface and the second strip defines the bottom surface of the coupon cards. A pair of exit rollers are mounted on the support frame with at least one of the exit rollers having a cutting surface thereon for completely cutting through the first and second strips of the series of two-sided coupon cards for forming and separating individual coupon cards from the continuous sheet of stock which converts the remaining continuous sheet of stock into a first continuous web of scrap stock. A first take-up roller is mounted on the support frame for collecting the first continuous web of scrap stock. A scoring roller is mounted on the support frame with the scoring roller having a cutting surface thereon for only cutting through a portion of the second strip of stock of the series of two-sided coupon cards. A stripping roller is mounted on the support frame for removing the cut portion of the second strip of stock from the remaining portions of the series of two-sided coupon cards which converts the cut portion of the second strip of stock into a second continuous web of scrap stock. A second take-up roller is mounted on the support frame for collecting the second continuous web of scrap stock.

The invention also includes an associated method of manufacturing the coupon card. The method comprises the steps of: printing indicia on the top surface of the continuous sheet of stock in two parallel rows to define the first strip and the second strip of the stock; removing the release liner from the first strip to expose the adhesive layer; mating the adhesive layer of the first strip with the release liner of the second strip to bond the first and second strips together and form the continuous series of two-sided coupon cards wherein the first strip defines the top surface and the second strip defines the bottom surface of the coupon cards; cutting completely through the first and second strips of the series of two-sided coupon cards for forming and separating individual coupon cards from the continuous sheet of stock and for converting the remaining continuous sheet of stock into a first continuous web of scrap stock; removing the first continuous web of scrap stock from the individual coupon cards; collecting the first continuous web of scrap stock; cutting through only a portion of the second strip of stock of the series of two-sided coupon cards; removing the cut portion of the second strip of stock from the remaining portions of the series of two-sided coupon cards which converts the cut portion of the second strip of stock into a second continuous web of scrap stock; and collecting the second continuous web of scrap stock.

Accordingly, the manufacturing machine assembly of the subject invention provides a quick and efficient means to manufacture a coupon card that improves on the manufacturing machines of the prior art and also produces a superior coupon card. The manufacturing machine assembly of the subject invention is particularly useful when producing larger foldable coupon cards.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic side view of a manufacturing machine assembly in accordance with the subject invention;

FIG. 2 is an exploded cross-sectional view taken along line 2-2 of FIG. 1;

FIG. 3 is a fragmentary top view taken along line 3 of FIG. 1;

FIG. 4 is a fragmentary perspective view of a cutting wheel;

FIG. 5 is a cross-sectional view taken along line 5-5 of FIG. 1;

FIG. 6 is a fragmentary perspective view of an inverting device;

FIG. 7 is a fragmentary perspective view of a non-stick roller, a pair of scoring rollers, and a pair of coupling rollers;

FIG. 8 is a cross-sectional view taken along line 8-8 of FIG. 7;

FIG. 9 is a cross-sectional view taken along line 9-9 of FIG. 7;

FIG. 10 is a fragmentary cross-sectional view taken along line 10-10 of FIG. 1;

FIG. 11 is a schematic side view of a series of tensioning rollers, a stripping roller, and a take-up roller;

FIG. 12 is an enlarged fragmentary perspective view of the stripping roller and take-up roller;

FIG. 13 is a fragmentary cross-sectional view taken along line 13-13 of FIG. 1;

FIG. 14 is a fragmentary perspective view of a pair of exit rollers;

FIG. 15 is an enlarged fragmentary perspective view of the exit rollers;

FIG. 16 is a fragmentary perspective view of the exit rollers, an exit chute and another take-up roller;

FIG. 17 is a perspective view of a top surface of a coupon card produced by the manufacturing machine assembly; and

FIG. 18 is a perspective view of a bottom surface of the coupon card.

### DETAILED DESCRIPTION OF THE INVENTION

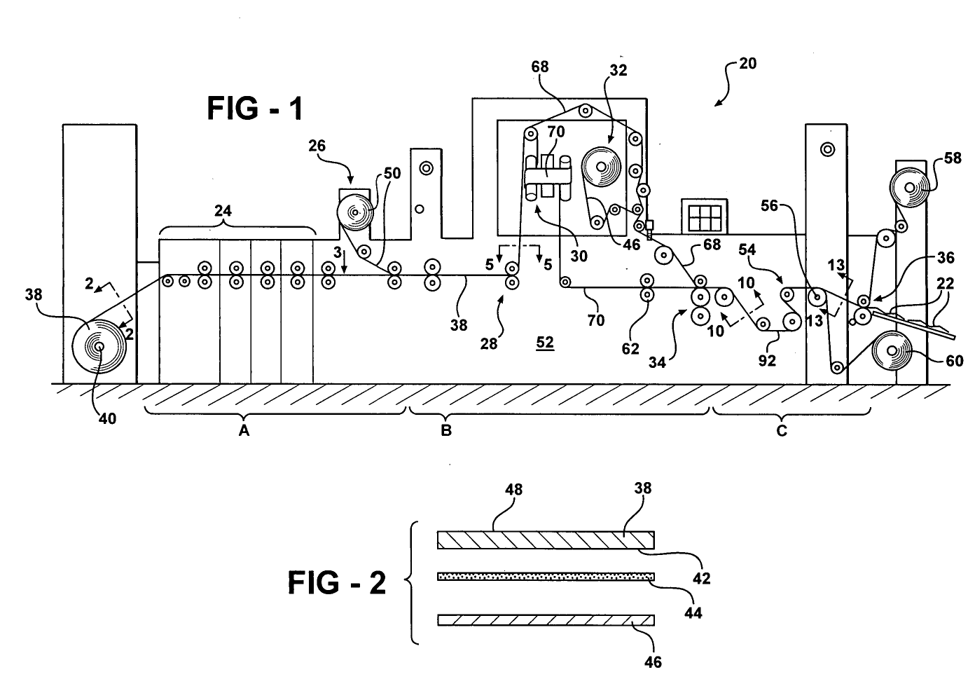

Referring to the Figures, wherein like numerals indicate like or corresponding parts throughout the several views, a card manufacturing machine assembly for producing an individual coupon card 22 is generally shown at 20 in FIG. 1. Specifically, FIG. 1 discloses a schematic front view of the card manufacturing machine assembly 20. The machine assembly 20 may be divided into three separate sections. Section A includes a printing station 24 and a laminating device 26. Section B is a forming station, which preferably includes a cutting device 28, an inverting device 30, a removal mechanism 32, and a pair of coupling rollers 34. Section C is an exit station and preferably includes a series of tensioning rollers 54, a stripping roller 56, an exit roller 36, and first 58 and second 60 take-up rollers.

A rolled continuous sheet of stock 38 is mounted to a rotating shaft 40 before the printing station 24 of section A. This continuous sheet of stock 38, which is shown exploded and in cross-section in FIG. 2, is also known in the art as a web sheet and may preferably be formed of card stock.

The continuous sheet of stock 38 has a bottom surface 42 with an adhesive layer 44 and a release liner 46 adhered thereto. The sheet of stock 38 also has a top surface 48 which can be covered by a clear laminate 50. The clear laminate 50 is discussed in greater detail below. For illustrative purposes in FIG. 2, the relative sizes of the adhesive layer 44 and release liner 46 are exaggerated. The release liner 46 also includes a silicone finish (not shown) disposed on at least one side which allows the release liner 46 to be removed from the adhesive layer 44 without removing the adhesive or damaging the sheet of stock 38.

A support frame 52 is provided for supporting the continuous sheet of stock 38 as the sheet of stock 38 moves through the machine assembly 20. In particular, the support frame 52 provides a support surface for numerous components of the manufacturing machine assembly 20, including the previously mentioned laminating device 26, cutting device 28, inverting device 30, removal mechanism 32, coupling rollers 34, tensioning rollers 54, stripping roller 56, exit roller 36, first take-up roller 58, and second take-up roller 60. The support frame 52 may be of any suitable size and shape as is known in the art.

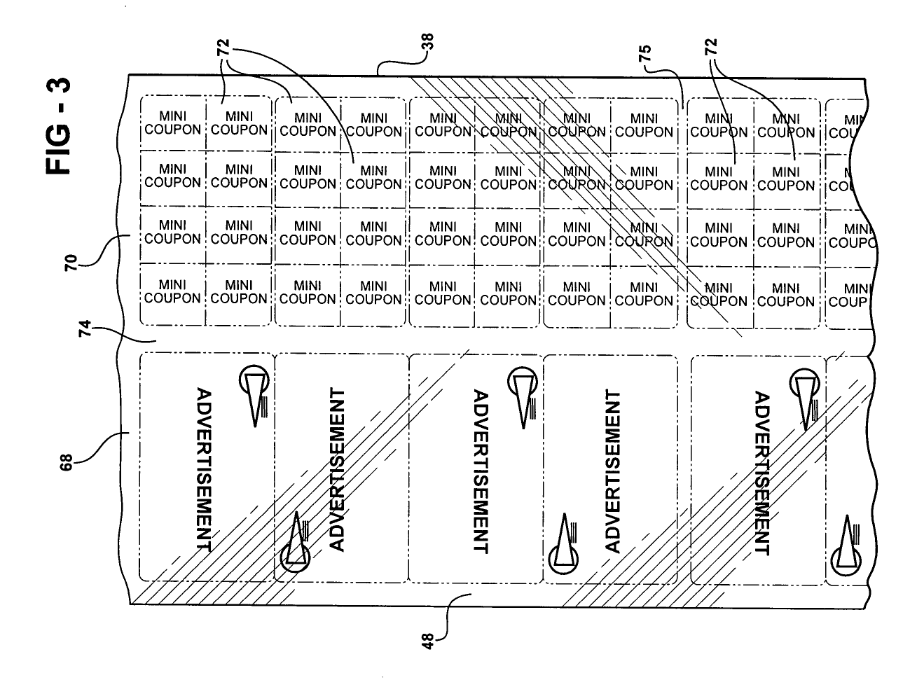

The forming of the coupon card 22 from the continuous sheet of stock 38 is now discussed in greater detail with reference to the remaining Figures. Referring to FIGS. 1 and 3, the continuous sheet of stock 38 is fed into the printing station 24 which prints indicia on the top surface 48 of the continuous sheet of stock 38 in two parallel rows at the same time, which define a first strip 68 and a second strip 70 of the sheet of stock 38. Current printing stations may utilize a number of Cyrel printing plates (not shown) as known to those skilled in the art. Variable speed laser printers may also be used as printing stations without deviating from the scope of the subject invention. The length of the printing station 24 is depended upon the number of colors used which in turn determines the number of printing plates and/or laser printers used.

As best shown in FIG. 3, the parallel rows define the first strip 68 and the second strip 70 of the sheet of stock 38 wherein these strips 68, 70 are continuously moving through the machine assembly 20 along a predetermined path. More specifically, the path is a longitudinal path that generally runs the lengthwise dimension of the manufacturing machine assembly 20. Commonly printed indicia comprises appropriate logo(s) and/or advertisement(s) which may include manufacturing, marketing, charity information, and the like. The preferred embodiment of the subject invention includes marketing information printed on the first strip 68 and a number of mini-coupons 72 and other related information printed on the second strip 70. A first unprinted line 74 separates the first 68 and second 70 strips and a second unprinted line 75 separates individual coupon cards 22 printed on the sheet of stock 38. The individual coupon cards 22 will be discussed in greater detail below. Preferably, the information printed on the first strip 68 is printed in alternating orientations, as shown in FIG. 3. The purpose for the alternating orientations will be discussed in greater detail below. As one skilled in the art can appreciate, any type or design of indicia may be printed on either the first 68 or second 70 strips without deviating from the scope of the subject invention. Further, the strips 68,70 may be of any length or width.

After the printing is completed, the laminating device 26 preferably applies the clear laminate 50 to the top surface 48 of the sheet of stock 38 for protecting and viewing the indicia. Specifically, the laminate 50 is a clear polyester laminate 50 that is rolled onto a shaft (not numbered) above the continuous sheet of stock 38. The laminate 50 protects the top surface 48 of the stock 38 and ensures that the indicia will not smear, rub off, or otherwise be damaged.

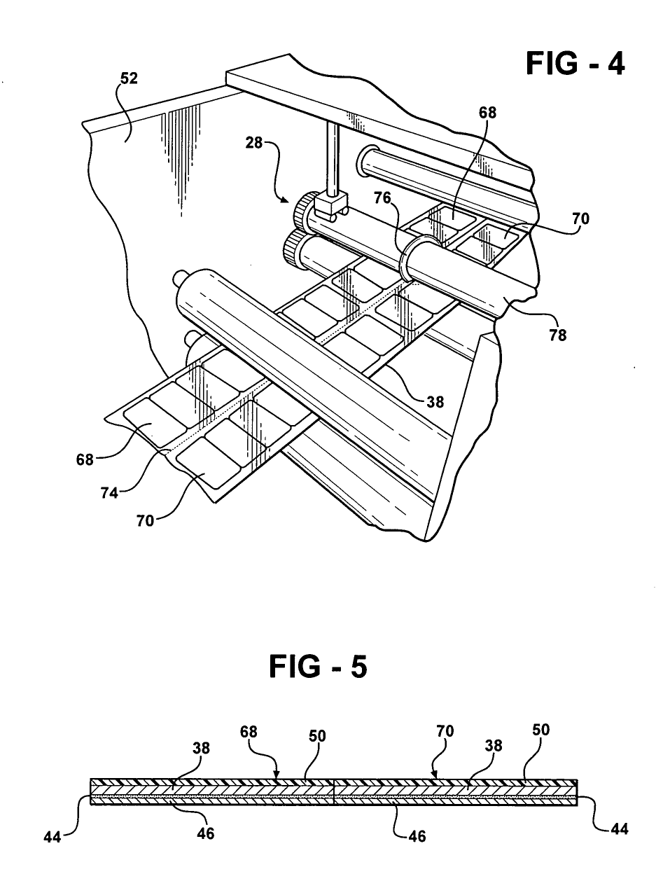

The continuous sheet of stock 38 then moves into the forming station of section B. The cutting device 28 separates the continuous sheet of stock 38 into the first 68 and second 70 strips. As best shown in FIG. 4, the cutting device 28 comprises an annular blade 76 anchored to a cutting roller 78. The sheet of stock 38 passes underneath the annular blade 76 wherein the annular blade 76 cuts through the sheet of stock 38 along the first unprinted line 74 between the first 68 and second 70 strips. Although the strips 68,70 are separated they remain in close proximity to each other. As best shown in FIG. 5, the first 68 and second 70 strips comprise the sheet of stock 38 with the adhesive layer 44 and the release liner 46 applied to the bottom surface 42 and the laminate 50 applied to the top surface 48.

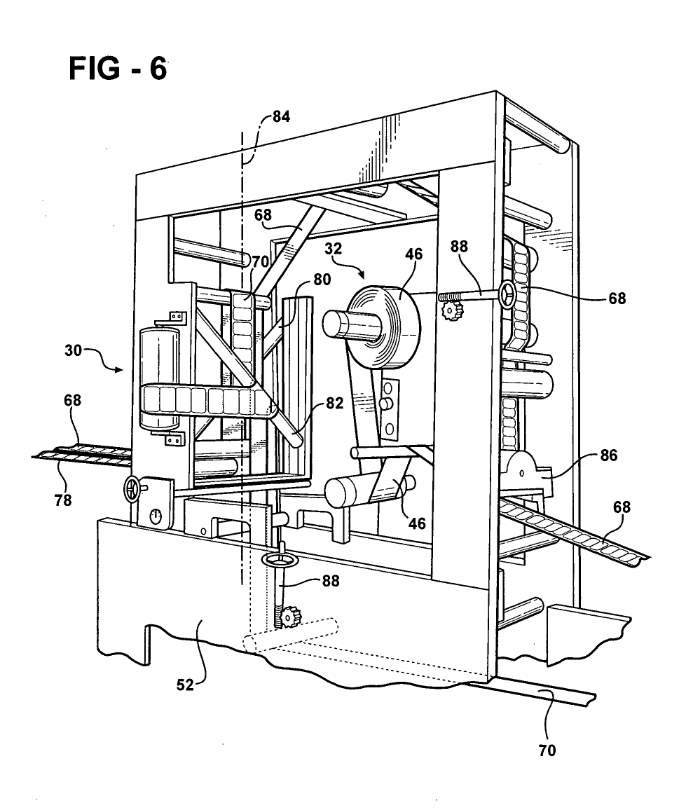

The continuous sheet of stock 38 then moves into the inverting device 30 where the first 68 and second 70 strips actually separate. The first strip 68 continues along the longitudinal path and passes over the second strip 70. In other words, the first strip 68 runs the lengthwise dimension of the manufacturing machine assembly 20. The second strip 70 separates from the first strip 68 and passes into the inverting device 30. The inverting device 30 is shown schematically in FIG. 1 and more specifically in FIG. 6. Generally, the inverting device 30 rotates one of the first 68 and second 70 strips 180 degrees relative to the other first 68 and second 70 strip. As one skilled in the art can appreciate, either of the strips 68, 70 may be inverted without deviating from the scope of the subject invention.

The inverting device 30 includes a first turn bar 80 and a second turn bar 82 with a vertical axis 84 passing through an intersection of the first 80 and second 82 turn bars. Preferably, the first turn bar 80 is positioned at a 45 degree angle clockwise with respect to the vertical axis 84 and the second turn bar 82 is positioned at a 45 degree counter-clockwise with respect to the vertical axis 84. As discussed above, the second strip 70 preferably passes around the turn bars 80, 82 to be inverted 180 degrees. The preferred embodiment of the turn bars 80, 82 creates the least amount of stresses on the sheet of stock 38 as the second strip 70 passes around the turn bars 80, 82. As known to those skilled in the art, the first turn bar 80 could be positioned at any acute angle with respect to the vertical axis 84 and the second turn bar 82 could be positioned at any acute angle with respect to the vertical axis 84 so long as the sum of the acute angles equals 90 degrees. The inverting device 30 may also include a number of additional bars and/or rollers for moving the second strip 70 of card stock 38 through the inverting device 30. The inverting device 30 and its unique operation and related components form the claimed subject matter of U.S. Pat. No. 5,776,287 which is assigned to the assignee of the subject invention and is herein incorporated by reference.

The removal mechanism 32 is also located within section B next to the inverting device 30. As best shown in FIG. 6, the removal mechanism 32 removes the release liner 46 from the first strip 68 to expose the adhesive layer 44. The release liner 46 is then rolled onto a shaft (not numbered). As one can appreciate, the release liner 46 may be removed from the second strip 70 without deviating from the scope of the subject invention. Immediately after the release liner 46 is removed, the first strip 68 passes through an electronic adjustment mechanism 86. Such electronic adjustment mechanisms electronically control the position of the corresponding strip 68, 70 as is known in the art.

At least one machine adjustment device 88 is disposed on the support frame 52 for adjusting the first 68 and second 70 strips as the first 68 and second 70 strips move through the inverting device 30 and along the longitudinal path through the machine assembly 20. As shown in FIG. 6, there are a number of manually operated adjustment mechanisms 88. However, any type or number of automatic or manual adjustment mechanism(s) may be utilized without deviating from the scope of the subject invention.

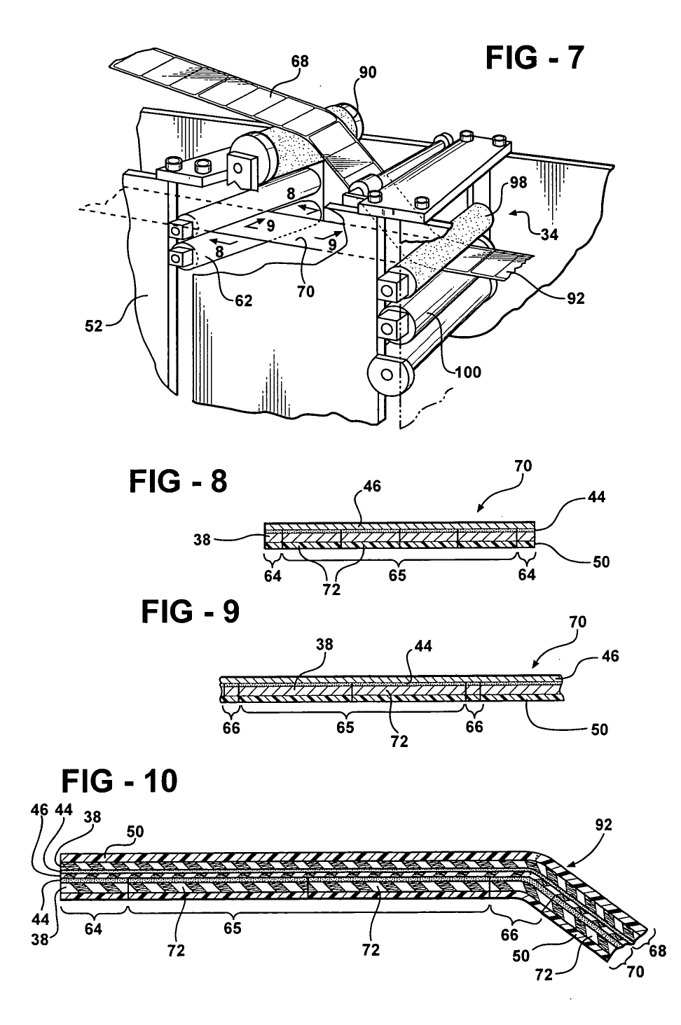

The first 68 and second 70 strips continue through section B of the card manufacturing machine assembly 20. As best shown in FIG. 7, the first strip 68, which has the adhesive layer 44 exposed, passes over a non-stick roller 90 having a plurality of looped fibers adhered thereto whereby the adhesive layer 44 of the first strip 68 does not adhere to the roller 90.

As shown in FIGS. 1 and 7, a scoring roller 62 is mounted on the support frame 52 and has a cutting surface thereon for only cutting through a portion of the second strip of stock 70. Preferably, the scoring roller 62 is mounted between the inverting device 30 and the coupling rollers 34. Hence, the second strip of stock 70 is cut before the first 68 and second 70 strips are bonded together by the coupling rollers 34.

FIGS. 8 and 9 illustrate widthwise and lengthwise cross-sectional views of the second strip of stock 70 immediately after passing through the scoring roller 62. As is clearly illustrated, the second strip 70 is now upside down as compared to the orientation of the second strip 70 before the second strip 70 passed through the inverting device 30, see FIG. 5. In the preferred embodiment, one portion of the second strip of stock 70 that is cut by the scoring roller 62 is a removable perimeter 64. Further, another preferred portion of the second strip of stock 70 that is cut by the scoring roller 62 is at least one removable center strip 66. As is discussed in greater detail below, the removable center strip 66 defines a living hinge for the coupon card 22. In the embodiment illustrated, there are three removable center strips 66. The cutting surface of the scoring roller 62 also preferably cuts through an interior section 65 of the second strip of stock 70 to define the plurality of removable mini-coupons 72. In the most preferred embodiment, the cutting surface of the scoring roller 62 cuts through the perimeter 64, center strips 66, and interior section 65 of the second strip of stock 70 simultaneously. The scoring is substantial enough such that the perimeter 64, center strips 66, and mini-coupons 72 may be removed without affecting the adhesion of the remaining mini-coupons 72. In particular, the scoring cuts through the laminate 50, sheet of stock 38, and adhesive layer 44. The scoring is preferably configured such that the center strips 66 remain attached to each adjacent perimeter 64. The scoring does not, however, sever the release liner 46 remaining on the second strip of stock 70.

After the first strip 68 passes over the non-stick roller 90 and the second strip 70 passes through the scoring roller 62, the first 68 and second 70 strips should be aligned both horizontally and longitudinally. In other words, the printed indicia of the first 68 strip should align with the printed indicia of the second strip 70.

The first 68 and second 70 strips now move into engagement with the coupling rollers 34. Specifically, the coupling rollers 34 move the adhesive layer 44 of the first strip 68 into a bonded relationship with the release liner 46 of the second strip 70 to mate the first 68 and second 70 strips and form a continuous series of two-sided coupon cards 92 with the indicia printed on both sides thereof. Preferably, the coupling rollers 34 comprise a top roller 98 and a bottom roller 100. The top roller 98 has a resilient, substantially rubber-like exterior for gripping the first strip 68 and creating the continuous series of two-sided coupon cards 92. The bottom roller 100 is a metal cylinder having a smooth exterior surface. The first 68 and second 70 strips interface with the top 98 and bottom 100 rollers which mates and adheres the strips 68, 70 together. As discussed above, once the strips 68, 70 have passed through the coupling rollers 34, the continuous sheet of stock 38 is transformed into the continuous series of two-sided coupon cards 92.

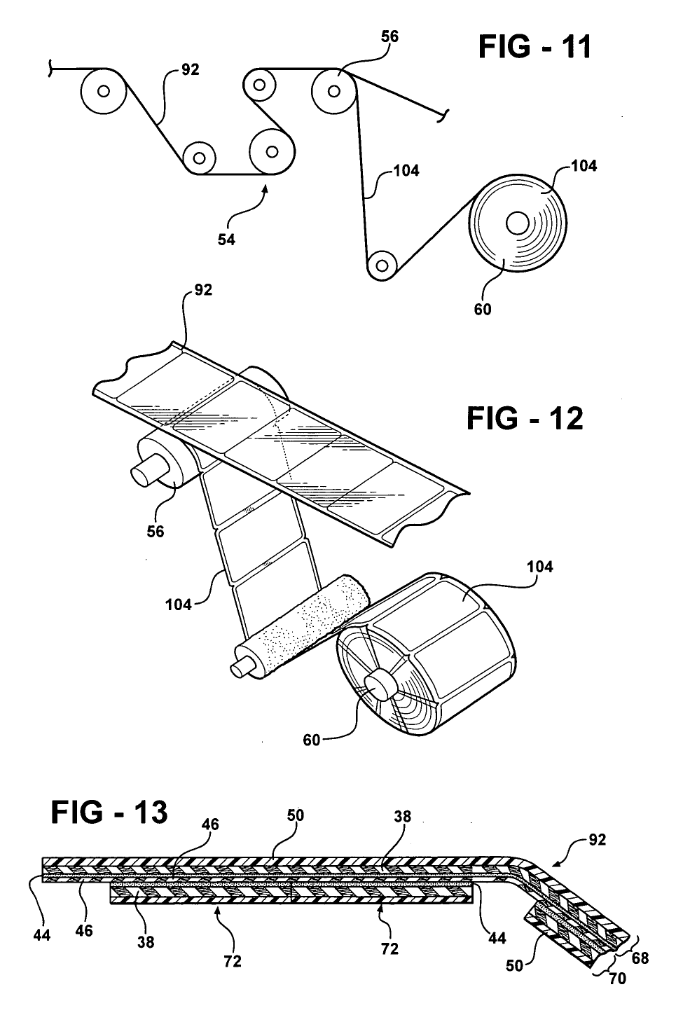

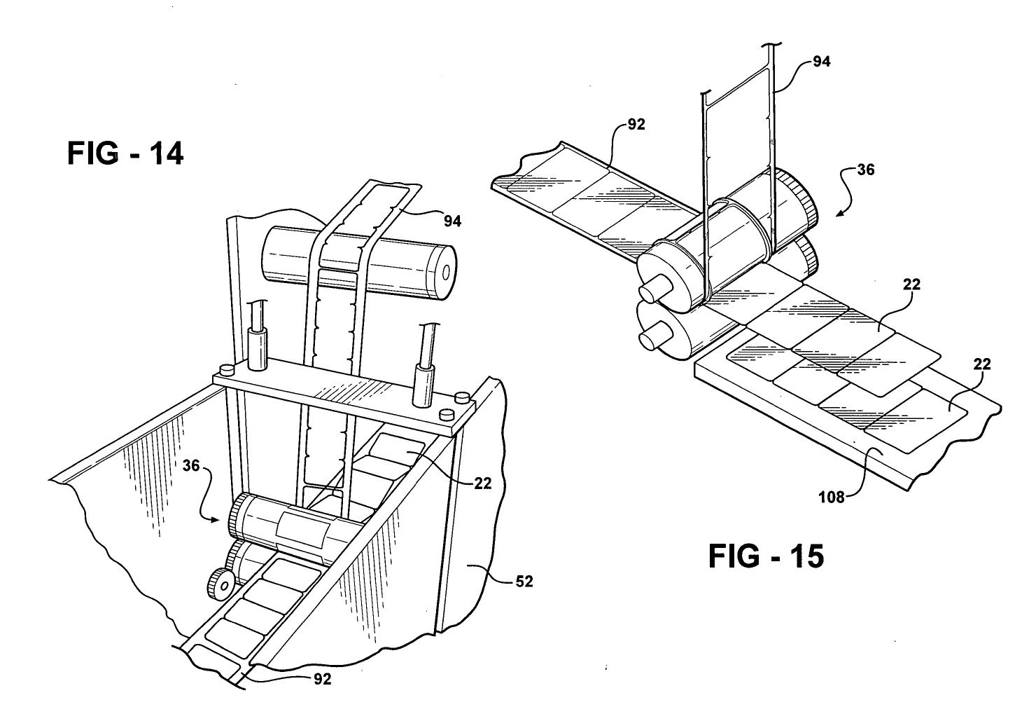

FIG. 10 illustrates a fragmented cross-sectional view of the continuous series of two-sided coupon cards 92 immediately after the strips 68, 70 are bonded together. The laminate 50 of the first strip 68 is now the top surface 48 of the coupon card 22, and the laminate 50 of the second strip 70 is now the bottom surface 42 of the coupon card 22. Hence, the first strip 68 defines the top surface 48 and the second strip 70 defines the bottom surface 42 of the series of two-sided coupon cards 92. In other words, the top surface 48 of the series of coupon cards 92 includes the marketing information printed thereon and the bottom surface 42 of the series of coupon cards 92 includes the mini-coupons 72 and other related information printed thereon. The continuous sheet of stock 38 having the two strips 68, 70 as shown in FIGS. 3, 4 and 5 is now converted to the continuous series of two-sided coupon cards 92, having two layers of card stock 38, as shown in FIGS. 7 and 10-15.

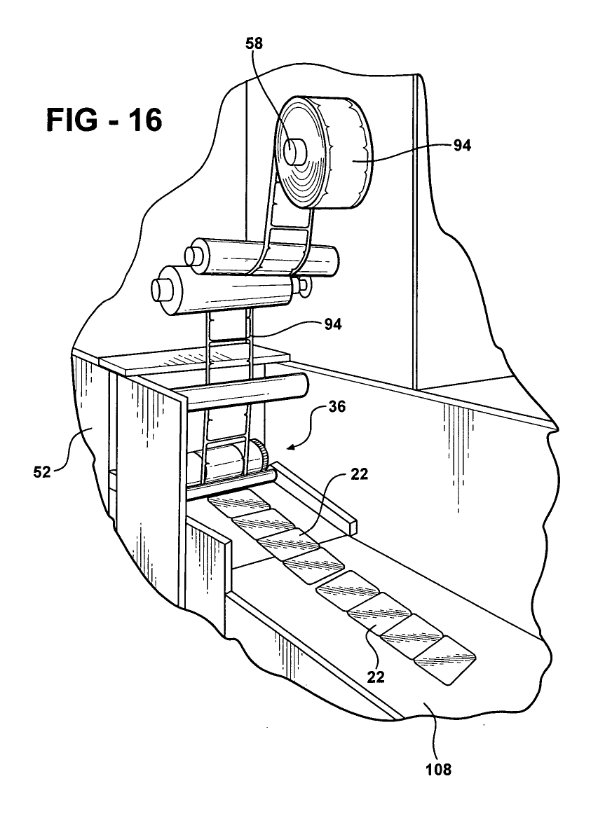

Referring to FIGS. 1 and 11-16, the continuous series of two-sided coupon cards 92 then moves into section C of the manufacturing machine assembly 20, which is the exit station. The series of two-sided coupon cards 92 passes through the series of tensioning rollers 54, which are disposed between the coupling rollers 34 and the stripping roller 56.

The series of two-sided coupon cards 92 now passes over the stripping roller 56, which is designed to remove at least some of the cut portions of the second strip of stock 70. In particular, the stripping roller 56 removes the cut portions of the second strip of stock 70 from the remaining portions of the series of two-sided coupon cards 92. Preferably, the perimeter 64 and center strips 66 of the second strip of stock 70 are removed simultaneously as the series of two-sided coupon cards 92 pass over the stripping roller 56. As shown, the continuous perimeter 64 and center strips 66 of the second strip 70 remain interconnected. This interconnected string of perimeters 64 and center strips 66 converts the cut portions of the second strip of stock 70 into a continuous web of scrap stock 104. The second take-up roller 60 is mounted on the support frame 52 for collecting the continuous web of scrap stock 104 of the stripping roller 56. FIG. 13 illustrates a fragmented section of the series of two-sided coupon cards 92 after the perimeters 64 and center strips 66 have been removed.

Referring now to FIGS. 1 and 14-16, the continuous series of two-sided coupon cards 92, which now has the perimeters 64 and center strips 66 of the second strip of stock 70 removed, continues through section C to a pair of exit rollers 102. At least one of the exit rollers 102 has a cutting surface thereon for completely cutting through the first 68 and second 70 strips of the series of two-sided coupon cards 92. The complete cutting of the first 68 and second 70 strips forms and separates individual coupon cards 22 from the continuous sheet of stock 38. The separated individual two-sided coupon cards 22 subsequently accumulate along an exit chute 108. The complete cutting of the first 68 and second 70 strips also converts the remaining continuous sheet of stock 38 into another continuous web of scrap stock 94. In order for the individual coupon cards 22 to be easily folded, as is discussed in greater detail below, the cutting surface of the exit rollers 102 simultaneously cuts through a center of the coupon cards 22 to form a series of notches 110 and define at least one foldable living hinge for each of the coupon cards 22. As discussed in detail below, each of the individual coupon cards 22 shown has three foldable living hinges.

The first take-up roller 58 is mounted on the support frame 52 for collecting the continuous web of scrap stock 94 from the exit rollers 102. Preferably, the first take-up roller 58 associated with the exit rollers 102 is mounted above the predetermined path and the second take-up roller 60 associated with the stripping roller 56 is mounted below the predetermined path. As is appreciated, the take-up rollers 58, 60 may be mounted in any suitable location.

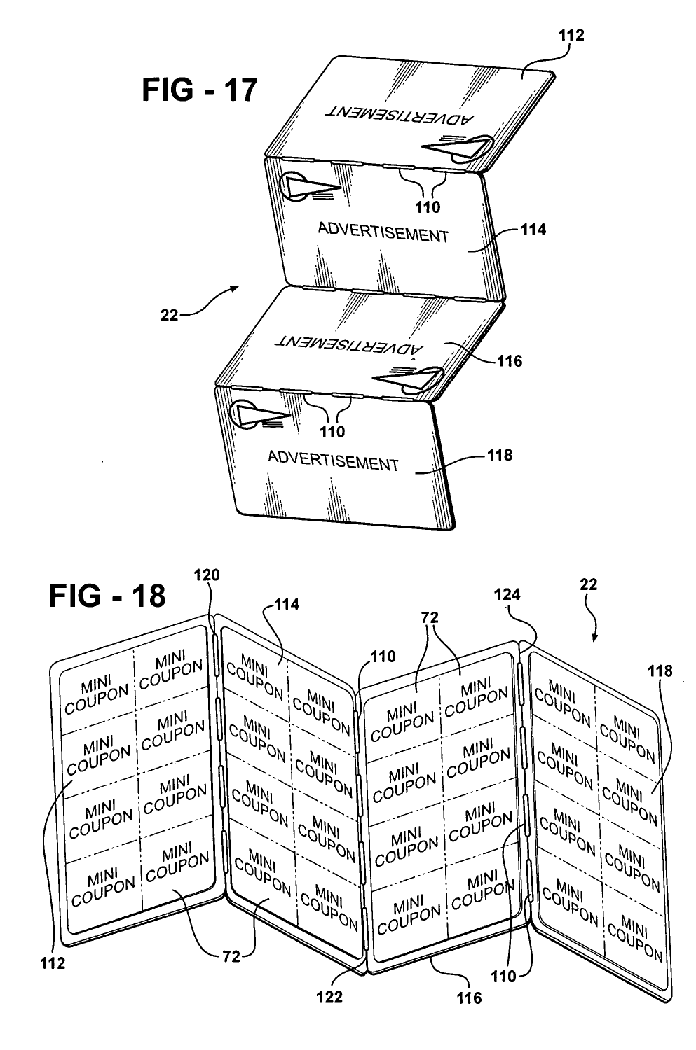

Referring to FIGS. 17 and 18, the individual coupon card 22 itself is shown in greater detail. The coupon card 22 comprises a first card 112 interconnected to a second card 114. At least one additional card is interconnected to the second card. Preferably, a third card 116 is interconnected to the second card 114 and a fourth card 118 is interconnected to the third card 116. It should be appreciated that there may be any number of cards interconnected together, such as 3,5,6, etc., without deviating from the overall scope of the subject invention. The cards 112, 114, 116, 118 have the identical unique construction set forth above which maintains the structural integrity for the entire multiple piece coupon card 22.

The coupon card 22 includes a first living hinge 120 interconnecting the first card 112 with the second card 114 wherein the first card 112 may be folded upon the second card 114. The coupon card 22 further includes a second living hinge 122 interconnecting the second card 114 with the third card 116, and a third living hinge 124 interconnecting the third card 116 with the fourth card 118 to define the multiple piece coupon card 22. The multiple piece coupon card 22 is illustrated in a partially folded position in FIGS. 17 and 18. It is appreciated that the first 112, second 114, third 116, and fourth 118 cards may be completely folded upon themselves such that the first 68 and second 70 strips of stock will overlay each other. As discussed above, appropriate marketing information, such as logos and/or advertisements are printed on the first strip 68 or top surface 48 and a number of mini-coupons 72 are printed on the second strip 70 or bottom surface 42. The information printed on the top surface 48 is printed in alternating orientations such that when the cards 112, 114, 116, 118 are overlaid onto themselves, the printed matter on the first 112 and third 116 cards are commonly orientated and the printed matter on the second 114 and fourth 118 cards are commonly orientated. It should be appreciated that the mini-coupons 72 printed on the bottom surface 42 may also be in alternating orientations.

The notches 110 in the center of the coupon cards 22 are aligned with the living hinges 120, 122, 124 for allowing the living hinges 120, 122, 124 to be easily folded. Preferably, the notches 110 span a majority of a width of the living hinges 120, 122, 124 such that the living hinges 120, 122, 124 easily fold when the cards 112, 114, 116, 118 are folded upon themselves. The living hinges 120, 122, 124 are relatively small in comparison to the overall length of the coupon card 22. The combination of the removed center strips 66, notches 110, and removed perimeters 64 creates an easily folded multiple piece coupon card 22. Further, the multiple piece coupon card 22 can be repeatedly folded without breaking or tearing due to the liner 46 being preferably formed of polyester. It is appreciated that during the manufacture of the card assembly, the notches 110 are also formed in the center strip 66 before the center strip 66 is removed.

The removal of the center strips 66 are particularly advantageous in that the living hinges 120, 122, 124 are not unnecessarily stressed and can therefore be made smaller. It should be appreciated that the notches 110 may be of any suitable size or length or even eliminated altogether. The removal of the center strips 66 allows the living hinges 120, 122, 124 to be folded with or without the formation of the notches 110.

The top surfaces 48, which are formed of the first strip of stock 68, of each of the cards 112, 114, 116, 118 are interconnected to define an integral homogenous sheet of stock. Similarly, the liners 46 of each of the cards 112, 114, 116, 118 are also interconnected to define the integral homogenous liner 46. The bottom surfaces 42, which are formed of the second strip of stock 70, of each of the cards 112, 114, 116, 118 are separated by the hinges 120, 122, 124 that have the center strips 66 removed. The first 68 and second 70 strips of stock are preferably of a paper stock material that can be easily printed thereon. The liner 46 is preferably a clear polyester liner 46 of 0.5 to 2.0 mils thick. More preferably, the liner 46 is 1.5 mils thick. This type of polyester liner 46 can be printed on and is tear resistant. As such, the structural integrity of the multi-piece coupon card 22 is improved. This improved strength and tear resistance is particularly important in a multi-piece coupon card having living hinges.

As discussed above, the plurality of mini-coupons 72 are detachably cut into the bottom surface 42 through the second layer of stock. Preferably, the mini-coupons 72 are cut such that, once removed, the mini-coupons 72 include a layer of stock 68, 70 covered with a laminate 50 on one side and an adhesive layer 44 on the other side. It is desirable to have the adhesive layer 44 removed with the mini-coupons 72 such that the mini-coupons 72 may be adhered to a redemption sheet at a place of purchase. In addition, the area of the coupon card 22 that was occupied by the mini-coupon 72 does not have a “tacky” feel which may be irritating to a user. It is appreciated that the mini-coupons 72 may be of any suitable size or configuration with any suitable type of promotional indicia disposed thereon.

Each card 112, 114, 116, 118 defines a respective outer periphery. As discussed in detail above, the bottom surface 42 of each card 112, 114, 116, 118 includes a cut spaced inwardly from the respective outer peripheries to form the removable perimeters 64. The perimeters 64 include a portion of the second strip of stock 70, the adhesive layer 44, and the laminate 50. Removal of the perimeters 64 exposes a peripheral ledge that enables access to the mini-coupons 72 positioned adjacent to the periphery of the coupon card 22. The peripheral ledge may be depressed to separate the mini-coupons 72 from the respective cards 112, 114, 116, 118 without compromising the integrity of the coupon card 22. In other words, the cards 112, 114, 116, 118 do not have to be significantly manipulated to remove a mini-coupon 72. Furthermore, removal of the perimeters 64 eliminates some of the material on the coupon card 22, thus decreasing bulkiness of the coupon card 22.

The method of manufacturing the coupon card 22 of the subject invention will now be discussed in further detail. The method first comprises the step of printing the indicia on the top surface 48 of the continuous sheet of stock 38 in two parallel rows to define the first strip 68 and the second strip of the stock 70. The clear laminate 50 is then applied to the top surface 48 of the continuous sheet of stock 38 for protecting and viewing the indicia.

The first 68 and second 70 strips are then cut and one of the first 68 and second 70 strips is inverted 180 degrees relative to the other first 68 and second 70 strip. The release liner 46 is removed from the first strip 68 to expose the adhesive layer 44. A portion of the second strip of stock 70 of the series of two-sided coupon cards 92 is cut. Preferably, the step of cutting through only the portion of the second strip of stock 70 is further defined as cutting through the perimeter 64 of the second strip of stock 70. Further, the step of cutting through only the portion of the second strip of stock 70 is further defined as cutting through at least one center strip 66 of the second strip of stock 70. The steps of cutting through the perimeter 64 and cutting through the center strip 66 of the second strip of stock 70 are performed simultaneously. In addition, the interior section 65 of the second strip of stock 70 is cut to form the plurality of removable mini-coupons 72. Preferably, the steps of cutting through the perimeter 64, center strip 66, and interior section 65 of the second strip of stock 70 are all performed simultaneously.

The adhesive layer 44 of the first strip 68 is then mated with the release liner 46 of the second strip 70 to bond the first 68 and second 70 strips together and form the continuous series of two-sided coupon cards 92 wherein the first strip 68 defines the top surface 48 and the second strip 70 defines the bottom surface 42 of the coupon cards 22. Preferably, the step of cutting through only the portion of the second strip of stock 70 is performed before the step of mating the strips 68, 70.

The cut portion of the second strip of stock 70 is removed from the remaining portions of the series of two-sided coupon cards 92. This removal converts the cut portion of the second strip of stock 70 into the continuous web of scrap stock 104. The continuous web of scrap stock 104 from the second strip of stock 70 is then collected. Preferably, the step of removing the cut portion of the second strip of stock 70 is further defined as simultaneously removing the perimeter 64 and center strip 66 of the second strip of stock 70, which are connected, to define the continuous web of scrap stock 104.

The first 68 and second 70 strips of the series of two-sided coupon cards 92 are now cut completely for forming and separating individual coupon cards 22 from the continuous sheet of stock 38 and for converting the remaining continuous sheet of stock 38 into another continuous web of scrap stock 94. The continuous sheet of stock 38 is tensioned between the steps of mating the strips and cutting completely through the strips 68, 70. The continuous web of scrap stock 94 associated with the first 68 and second 70 strips is removed from the individual coupon cards 22. This continuous web of scrap stock 94 is then collected. A center of the coupon cards 22 is also cut to form a series of notches 110 and define at least one foldable hinge for each of the coupon cards 22.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, the invention may be practiced otherwise than as specifically described

1. A card manufacturing machine assembly for producing a coupon card fabricated from a continuous sheet of stock having a top surface and a bottom surface with an adhesive layer and release liner disposed on said bottom surface, said assembly comprising:
a support frame for supporting the continuous sheet of stock as the sheet of stock moves through said machine assembly;
a printing station for printing indicia on the top surface of the continuous sheet of stock in two parallel rows that define a first strip and a second strip of the stock;
a forming station for removing the release liner from the first strip to expose the adhesive layer and for moving the adhesive layer of the first strip into a bonded relationship with the release liner of the second strip to mate the first and second strips and form a continuous series of two-sided coupon cards wherein the first strip defines the top surface and the second strip defines the bottom surface of the coupon cards;
a pair of exit rollers mounted on said support frame with at least one of said exit rollers having a cutting surface thereon for completely cutting through said first and second strips of the series of two-sided coupon cards for forming and separating individual coupon cards from the continuous sheet of stock which converts the remaining continuous sheet of stock into a first continuous web of scrap stock; and
a first take-up roller mounted on said support frame for collecting the first continuous web of scrap stock;
a scoring roller mounted on said support frame with said scoring roller having a cutting surface thereon for only cutting through a portion of said second strip of stock;
a stripping roller mounted on said support frame for removing the cut portion of the second strip of stock from the remaining portions of the series of two-sided coupon cards which converts the cut portion of the second strip of stock into a second continuous web of scrap stock; and
a second take-up roller mounted on said support frame for collecting the second continuous web of scrap stock.

2. An assembly as set forth in claim 1 wherein said forming station includes a cutting device mounted on said support frame for separating the continuous sheet of stock into the first and second strips.

3. An assembly as set forth in claim 2 wherein said forming station further includes an inverting device mounted on said support frame for rotating one of the first and second strips 180 degrees relative to the other first and second strip.

4. An assembly as set forth in claim 3 wherein said forming station further includes a removal mechanism mounted on said support frame for removing the release liner from the first strip to expose the adhesive layer.

5. An assembly as set forth in claim 4 wherein said forming station further includes a pair of coupling rollers mounted on said support frame for moving the adhesive layer of the first strip into a bonded relationship with the release liner of the second strip.

6. An assembly as set forth in claim 5 wherein said scoring roller is mounted on said support frame between said inverting device and said coupling rollers such that said second strip of stock is cut before said first and second strips of stock are bonded together.

7. An assembly as set forth in claim 1 wherein said exit rollers, stripping roller, and said first and second take-up rollers combine to form an exit station.

8. An assembly as set forth in claim 1 wherein said exit station further includes a series of tensioning rollers disposed between said coupling rollers and said stripping roller.

9. An assembly as set forth in claim 1 wherein the cut portion of the second strip of stock is further defined as a removable perimeter.

10. An assembly as set forth in claim 9 wherein the cut portion of the second strip of stock is further defined as at least one removable center strip.

11. An assembly as set forth in claim 10 wherein the perimeter and the center strip of the second strip of stock are removed simultaneously.

12. An assembly as set forth in claim 11 wherein the perimeter and the center strip of the second strip remain interconnected and define the second continuous web of scrap stock collected by said second take-up roller.

13. An assembly as set forth in claim 12 wherein said cutting surface of said scoring roller cuts through an interior section of the second strip of stock to define a plurality of removable mini-coupons.

14. An assembly as set forth in claim 13 wherein said cutting surface of said scoring rollers cuts through the perimeter, center strip, and interior section of the second strip of stock simultaneously.

15. An assembly as set forth in claim 1 wherein said cutting surface of said exit rollers simultaneously cuts through a center of said coupon cards to form a series of notches and define at least one foldable hinge for each of the coupon cards.

16. An assembly as set forth in claim 1 further including a laminating device mounted to said support frame for applying a clear laminate to the top surface of the continuous sheet of stock for protecting and viewing the indicia.

17. An assembly as set forth in claim 1 wherein the continuous sheet of stock moves through said machine assembly along a predetermined path and wherein said first take-up roller is mounted above said predetermined path and said second take-up roller is mounted below said predetermined path.

18. A method of manufacturing a coupon card fabricated from a continuous sheet of stock having a top surface and a bottom surface with an adhesive layer and release liner disposed on said bottom surface, said method comprising the steps of:
printing indicia on the top surface of the continuous sheet of stock in two parallel rows to define a first strip and a second strip of the stock;
removing the release liner from the first strip to expose the adhesive layer;
mating the adhesive layer of the first strip with the release liner of the second strip to bond the first and second strips together and form a continuous series of two-sided coupon cards wherein the first strip defines the top surface and the second strip defines the bottom surface of the coupon cards;
cutting completely through the first and second strips of the series of two-sided coupon cards for forming and separating individual coupon cards from the continuous sheet of stock and for converting the remaining continuous sheet of stock into a first continuous web of scrap stock;
removing the first continuous web of scrap stock from the individual coupon cards;
collecting the first continuous web of scrap stock;
cutting through only a portion of the second strip of stock of the series of two-sided coupon cards;
removing the cut portion of the second strip of stock from the remaining portions of the series of two-sided coupon cards which converts the cut portion of the second strip of stock into a second continuous web of scrap stock; and
collecting the second continuous web of scrap stock.

19. A method as set forth in claim 18 further including the step of inverting one of the first and second strips 180 degrees relative to the other first and second strip before the step of mating the strips.

20. A method as set forth in claim 18 wherein the step of cutting through only a portion of the second strip of stock is performed before the step of mating the strips.

21. A method as set forth in claim 18 further including the step of tensioning the continuous sheet of stock between the steps of mating the strips and cutting completely through the strips.

22. A method as set forth in claim 18 wherein the step of cutting through only a portion of the second strip of stock is further defined as cutting through a perimeter of the second strip of stock.

23. A method as set forth in claim 22 wherein the step of cutting through only a portion of the second strip of stock is further defined as cutting through at least one center strip of the second strip of stock.

24. A method as set forth in claim 23 wherein the steps of cutting through a perimeter and cutting through a center strip of the second strip of stock are performed simultaneously.

25. A method as set forth in claim 24 wherein the step of removing the cut portion of the second strip of stock is further defined as simultaneously removing the perimeter and center strip of the second strip of stock to define the second continuous web of scrap stock.

26. A method as set forth in claim 25 further including the step of cutting through an interior section of the second strip of stock to form a plurality of removable mini-coupons.

27. A method as set forth in claim 26 wherein the steps of cutting through the perimeter, center strip, and interior section of the second strip of stock is performed simultaneously.

28. A method as set forth in claim 18 further including the step of cutting through a center of the coupon cards to form a series of notches and define at least one foldable hinge for each of the coupon cards.

29. A method as set forth in claim 18 further including the step of applying a clear laminate to the top surface of the continuous sheet of stock for protecting and viewing the indicia.
